(19) United States
(12) Patent Application Publication
(10) Pub. No.: US 2004/0062462 A1
(43) Pub. Date: Apr. 1, 2004

(54) Bearing assembly comprising radial run-out compensating means and radial run-out compensating method

(76) Inventors: Pierre Georges Jules Jacquet, Belfort (FR); Marc Dahan, Besancon (FR); Camille Pierre Marie Garcin, Gondenans-Les-Moulins (FR)

Correspondence Address: YOUNG & THOMPSON, 745 SOUTH 23RD STREET 2ND FLOOR, ARLINGTON, VA, 22202

(21) Appl. No.: 10/415,371

(22) PCT Filed: Oct. 26, 2001
(86) PCT No.: PCT/FR01/03346

(30) Foreign Application Priority Data
Oct. 27, 2000 (FR) 00/13873

(51) Int. Cl. F16C 19/50; F16C 23/04; F16C 23/08

(52) U.S. Cl. 384/495; 384/447

(57) ABSTRACT

A bearing assembly comprises clearance-tree outer and inner ball raceways which define outer and inner rings supporting the inner and outer spherical and eccentric annular spaces, and eccentric outer and inner ball raceways respectively arranged in the outer and annular spaces, and elements for tilting by sliding the eccentric outer and inner ball raceways, to compensate run-outs. The invention is applicable to ball-, roller- or needle-antifriction bearings.

The invention concerns generally a roller bearing having a capacity of correcting radial run-outs of said bearing as well as a method for correcting the radial run-out of a roller bearing.

When producing a roller bearing, it is possible to reduce uncertainties regarding the position and the rotation of the bearing elements, including internal clearances, thanks to tight assembly of said elements. Thus, a means known to adjust the dispersion on the centre distance of axes and the defect in parallelism of a roller bearing consists of multipoint supports exerted by screws on the bearing stand, but this means lacks sensitivity and rigidity. However, the lack of rigidity can be compensated for by casting a resin filling the clearance between the stand and the frame. However, even when all the clearances have been eliminated, there remain the radial run-outs of all the concentric rings of the bearing.

Until now, the solution consists in machining rings with reduced radial run-outs. Such solution is not only costly, but even if the radial run-outs are reduced to the maximum, they have a cumulative effect, and when assembling ball races, their eccentricity will always be induced. There has not been, to this day, any known solution which enables to correct the radial run-outs of a roller bearing.

This invention therefore suggests a roller bearing showing a capacity for correcting radial run-outs.

This invention also provides a method for correcting the radial run-outs of a roller bearing. The above aims are satisfied according to the invention while placing in a zero clearance bearing:

between a spherical outer surface of an outer ball race and a spherical inner surface of an outer support of the outer bearing ring, a spherical eccentric ring being slideable on the outer spherical surface of the outer bearing ring and on the inner spherical surface of the outer support of the outer ring, and

between a spherical outer surface of an inner support of the inner bearing ring and an eccentric outer surface of an inner ball race, a spherical eccentric ring being slideable on the outer spherical surface of the inner support and the outer spherical surface of the inner bearing ring.

More precisely, this invention provides a roller bearing fitted with a means for correcting radial run-outs which comprises after assembly with zero clearance:

an outer ball race having an outer bearing surface and an inner bearing surface,

an inner ball race having an outer bearing surface and an inner bearing surface,

bearing elements arranged between the inner bearing surfaces of the outer and inner ball races,

an outer mantle ring and an inner mantle ring, each having an inner surface, the ball races being held between the inner surfaces of the outer and inner mantle rings,

characterised in that:

the outer surface of the outer bearing ring and the inner surface of the outer mantle ring are spherical surfaces whereof the centres situated on the same axis of revolution, are spaced from one another, so that such surfaces delineate together a spherical and eccentric annular space, external to the bearing,

an eccentric outer ring, matching the shape of the outer annular space, and arranged in said space,

the outer surface of the inner bearing ring and the inner surface of the inner mantle ring are spherical surfaces whereof the centres situated on the same axis of revolution are spaced from one another so that such surfaces delineate together a spherical and eccentric annular space, internal to the bearing,

an eccentric inner ring, matching the shape of the inner annular space, and arranged in said space, and also characterised in that means are provided to tip up the eccentric rings inner and outer slidingly in annular spaces, thanks to which the radial run-outs can be corrected.

The bearings according to the invention can be any type of roller bearings such as ball bearings, roller bearings or needle bearings, preferably ball bearings or roller bearings.

In a preferred embodiment of the invention, the means for tipping the eccentric rings are composed of three adjustment screws arranged at 120° on a periphery of the eccentric rings. One may also use four adjustment screws spaced at 90°.

In another embodiment of the invention, the roller bearing defined above has been modified to enable global adjustment of the warping independently of the radial run-outs. To do so, means are provided to move the inner and outer ball races slidingly. Such means comprise advantageously screws, for example three compression screws spaced at 120° resting on a periphery of the ball races.

The following specification refer to the appended figures which represent respectively:

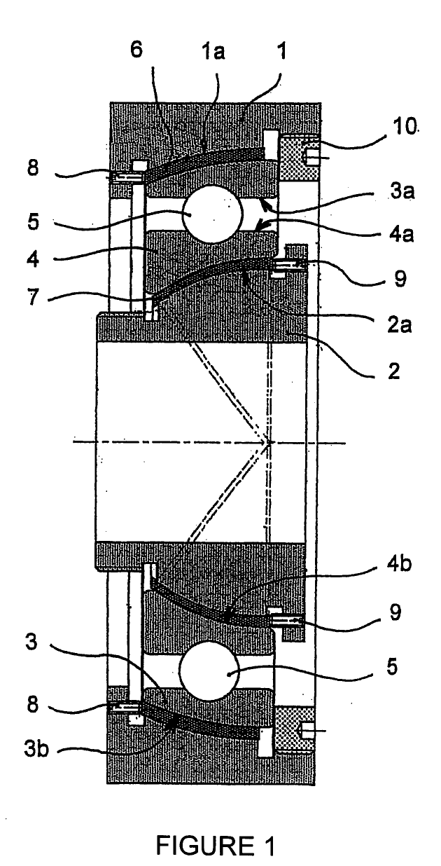

FIG. 1, a schematic sectional view of a ball roller bearing according to the invention.

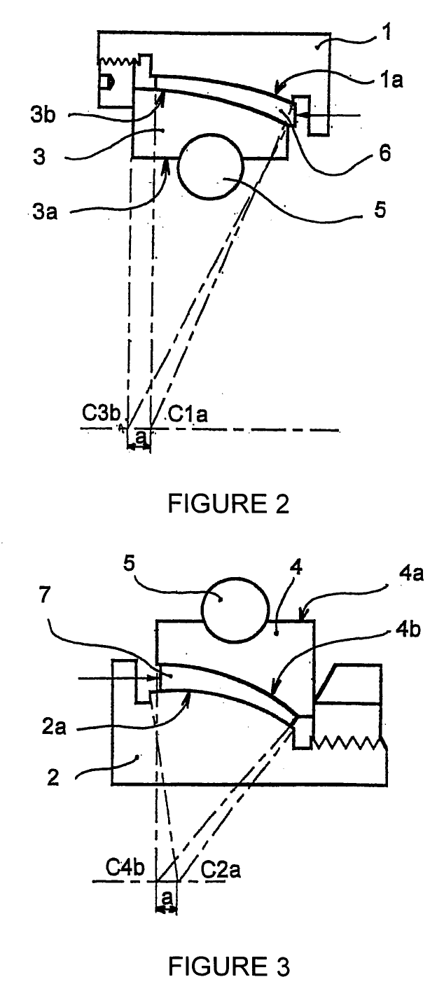

FIG. 2, an enlarged schematic view of the assembly of the outer bearing ring of the bearing of FIG. 1, showing the offset centres of the spherical surfaces.

FIG. 3, an enlarged schematic view of the assembly of the inner bearing ring of the bearing of FIG. 1, showing the offset centres of the spherical surfaces.

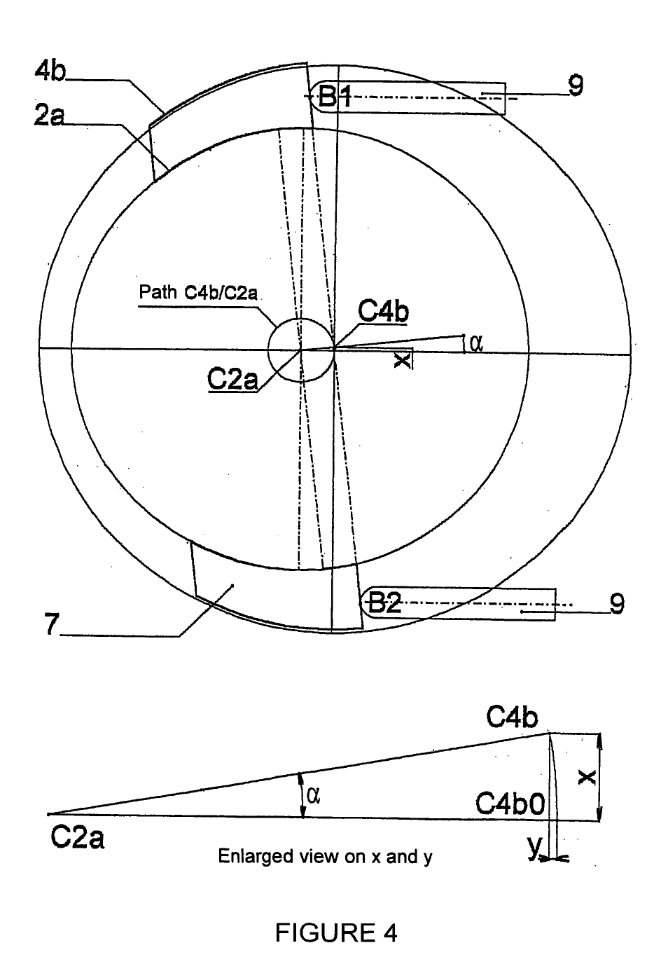

FIG. 4, a schematic sectional view of the assembly of a spherical eccentric ring situated in the inner annular space.

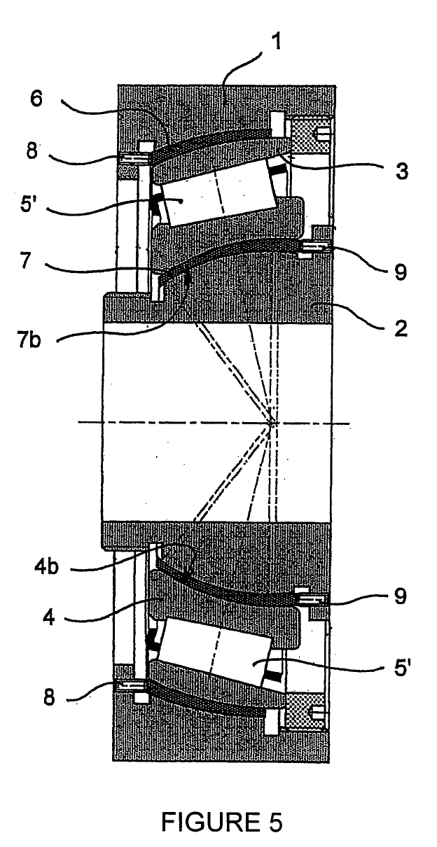

FIG. 5, a schematic sectional view of a roller bearing according to the invention.

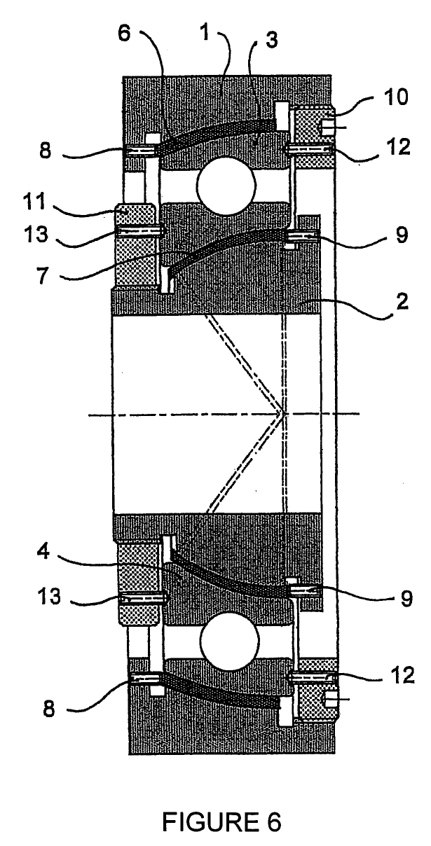

FIG. 6, a schematic sectional view of the bearing of FIG. 1, comprising means for adjusting the warping.

While referring to figures where the same elements are marked with the same reference numbers, and more particularly to FIG. 1, a ball roller bearing according to the invention is shown. The bearing comprises, conventionally, an outer mantle ring 1 and an inner mantle ring 2 holding together an outer ball race 3 and an inner ball race 4 trapping bearing balls 5. The assembly is held by at least one nut 10.

The structure which has just been described is classic and as it is well known, the outer mantle ring 1 is generally attached to a frame and remains fixed whereas the inner mantle ring 2 is shrunk-fitted on a rotary shaft (not represented) and rotates with the latter.

As can be seen on FIG. 1, the outer surface 3b of the outer bearing ring 3 and the outer surface 4b of the inner bearing ring 4 are spherical. Similarly, the inner surface 1a of the outer mantle ring1 and the inner surface 2a of the inner mantle ring 2 are spherical.

FIG. 2 shows that the centre C1a of the inner spherical surface 1a of the outer mantle ring 1 and the centre C3b of the outer spherical surface 3b of the outer bearing ring 3 are situated on the axis of the bearing, but spaced apart from one another, thereby creating between the spherical surfaces 1a and 3b, an outer eccentric annular space.

FIG. 2 also shows that an eccentric ring 6 is arranged in the outer annular space, i.e. between the inner spherical surface 1a of the outer spherical mantle ring 1 and the outer spherical surface 3b of the outer bearing ring 3. The eccentric ring 6 matches the shape of said outer annular space.

FIG. 3 shows that the centre C4b of the outer spherical surface 4b of the inner bearing ring 4 and the centre C2a of the inner spherical surface 2a of the inner mantle ring 2 are situated on the axis of the bearing, but spaced apart from one another thereby creating between the spherical surfaces, an inner eccentric annular space.

FIG. 3 also shows that an eccentric ring 7 is arranged in the inner annular space, i.e. between the outer spherical surface 4b of the inner bearing ring 4 and the inner spherical surface 2a of the inner mantle ring 2.

According to FIG. 1, adjustment screws 8 and 9 are provided to rest on one of the peripheries of the eccentric rings 6 and 7, respectively, in order to tip, by turning the screws, the eccentric rings 6 and 7 on the corresponding spherical surfaces of the mantle rings 1, 2 and of the ball races 3, 4 in order to correct any radial run-outs which may be present.

As can be seen better on FIG. 4, the centres C2a and C4b of the spherical surfaces 2a and 4b are on the axis of the bearing but offset by a distance a, as are also the centres C1a and C3b of the spherical surfaces 1a and 3b. This offset can be the same or different.

As the eccentric rings 6 and 7 match respectively the outer and inner annular spaces, their inner surfaces 6a, 7a and outer surface 6b, 7b are complementary to the spherical surfaces of the mantle rings and to the corresponding ball races, respectively 3b and 4b on the one hand, and 1a and 2a, on the other hand. Consequently, their centres are also on the axis of the bearing, but are also spaced apart by a distance a.

The eccentric rings 6 and 7 are analogue to connecting rods which are ball-jointed at each of their ends. A particularity lies in that the connecting rod is very short a (offset of the centres) in front of the radius R of the ball-joints (R/a>20). The centre of a ball-joint describes therefore a spherical cap with radius a around the centre of the other ball-joint. The displacement of a ball race with respect to its mantle ring comprises two translations with spherical path and three rotations. This punctual link is turned into a complete link thanks to a wedging effect produced when the fastening screws are tightened (the wedging is analogue to that of a conical shrunk-fit). The three-dimensional eccentric rings 6, 7 are capable to generate an eccentricity which contains the zero, and whereof the maximum amplitude is sufficient to absorb the uncertainty. The spurious axial displacement is negligible.

For exemplification purposes illustrated on FIG. 4, the distance a is set equal to 1.25 mm. Let us consider B1 and B2 as the application points of the screws 9 on the eccentric ring 7. Both the distances between C2a and B1 on the one hand, and C2a and B2 on the other, are equal to 25 mm. The screws 9 have a pitch of 0.5 mm. If B2 is loosened by two turns whereas B1 is tightened by two turns, the eccentric ring 7 tips by an angle α whereof the tangent has a value close to 1/25=0.04 corresponding to an angle of 2.29°. The radial displacement x of C4b complies with the following relation:

x=a tan α=1.25×0.04=0.05 mm=50 μm.

The spurious axial component y satisfies the relation hereunder:

y=a.(1−cos α)=1.25 (1−cos 2.29°)=0.001 mm=1 μm.

The tipping angle a is vastly smaller than the friction angle to provide the wedging effect during the tightening operation.

The dimensional dispersion and the parallelism condition on the frame involve a larger adjustment field for the position uncertainty than for the rotation uncertainty. However, generally, the outer mantle ring 1 and the outer ball race 3 are in the frame and fixed, and the inner mantle ring 2 and the inner bearing ring 4, are attached to a shaft and rotate with the latter. Consequently, for the outer mantle ring 1 and the outer bearing ring 3, the ball-joints are larger and, to obtain increased sensitivity, the distance between the centres C3b and C1a may be reduced (or those between C4b and C2a), or the distances C3bB1 and C3bB2 may be increased (or C4bB1 and C4bB2).

The invention enables to use ball races and mantle rings having radial run-outs greater than those tolerated previously. In such a case, the spherical cap delineated by the centres of the ball-joints is widened. For example, for a=2.5 mm and a tipping angle still of 2.29°, one obtains a maximum radial translation x=100 μm (maximum run-out which can be compensated for =200 μm) and a spurious axial component y=2 μm.

FIG. 5 shows roller bearing incorporating this invention. Apart from the use of rollers 5′ instead of balls 5 and the adaptation of the ball races 3, 4 to the rollers 5′, the radial run-outs are adjusted as previously.

FIG. 6 represents a bearing similar to that of FIG. 1, wherein a possibility of adjusting the warping has been integrated. As regards the warping, the orientation of the ball races is given by the face of the nuts 10 and 11. Compression screws 12, 13 are provided, for example three compression screws spaced at 120°, inserted respectively in each of the nuts 10, and resting respectively on the periphery of the outer bearing ring 3 (screw 12) and the periphery of the inner bearing ring 4 (screw 13). One may thus, by turning the screws 12, 13 adjust the final warping of the ball races, independently of the radial run-outs.

Preferably, washers (not represented) are interposed between the screws and the ball races. Preferably, the washers are washer with a flat face and a spherical face, whereas the flat surface rests preferably on the ball race.

1. A roller bearing which comprises, after assembly with zero clearance:
an outer ball race (3) having an outer bearing surface (3b) and an inner bearing surface (3a),
an inner ball race (4) having an outer bearing surface (4b) and an inner bearing surface (4a),
bearing elements (5, 5′) arranged between the inner bearing surfaces (3a, 4a) of the outer (3) and inner (4) ball races, respectively,
an outer mantle ring (1) having an inner surface (1a) and an inner mantle ring (2) having an inner surface (2a),
characterised in that:
the outer surface (3b) of the outer bearing ring (3) and the inner surface (1a) of the outer mantle ring(1) are des spherical surfaces whereof the respective centres (C3b) and (C1a), situated on the same axis of revolution, are spaced from one another, so that the surfaces (3b) and (1a) delineate together an eccentric and spherical outer annular space,
an eccentric outer ring (6), matching the shape of said outer annular space and arranged in said space,
the outer surface (4b) of the inner bearing ring (4) and the inner surface (2a) of the inner mantle ring (2) are spherical surfaces whereof the centres (C4b) and (C2a), situated on the same axis of revolution are spaced from one another, so that the surfaces (4b) and (2a) delineate together an eccentric and spherical inner annular space,
an eccentric inner ring (7) matching the shape of said inner annular space and arranged in said space;
and in that
means (8, 9) are provided to tip up the outer (6) and inner (7) eccentric rings, respectively, slidingly into the outer and inner annular spaces,
thanks to which the radial run-outs can be corrected.

2. A roller bearing according to claim 1, characterised in that the tipping means (8, 9) are composed of several adjustment screws arranged on a periphery of the eccentric rings (6, 7).

3. A roller bearing according to claim (2), characterised in that the adjustment screws are three in number and are arranged at 120° on the periphery of the eccentric rings (6, 7).

4. A roller bearing according to claim 2, characterised in that the adjustment screw are four in number and are arranged at 90° on the periphery of the eccentric rings (6, 7).

5. A roller bearing according to any of the previous claims, characterised in that the roller bearing is selected among ball bearings, roller bearings or needle bearings, preferably ball bearings or roller bearings.

6. A roller bearing according to any of the previous claims, characterised in that it comprises means (12, 13) to move the outer (3) and inner (4) ball races slidingly, thanks to which the global warping can be corrected independently of radial run-outs.

7. A roller bearing according to claim 6, characterised in that the sliding motion means (12, 13) are three compression screws arranged at 120° on a periphery of the ball races (3, 4).

8. A method for correcting the radial run-outs of a zero clearance bearing composed of:
an outer ball race (3) having an outer bearing surface (3b) and an inner bearing surface (3a),
an inner ball race (4) having an outer bearing surface (4b) and an inner bearing surface (4a),
bearing elements (5, 5′) arranged between the inner bearing surfaces (3a, 4a) of the outer (3) and inner (4) ball races, respectively,
an outer mantle ring (1) having an inner surface (la) and an inner mantle ring (2) having an inner surface (2a),
said ball races (3, 4) being held between the inner surfaces (1a, 2a) of the outer (1) and inner (2) mantle rings,
characterised in that it consists in placing in the zero clearance bearing:
an eccentric outer ring (6) between the outer surface (3b) of the outer bearing ring (3) and the inner surface (1a) of the outer mantle ring (1), said outer surface (3b) of the outer bearing ring (3) and inner surface (1a) of the outer mantle ring (1) being spherical, said eccentric outer ring (6) being slideable on the outer spherical surface (3b) of the outer bearing ring (3) and on the inner spherical surface (1a) of the outer mantle ring(1), and
an eccentric inner ring (7) between the outer surface (4b) of the inner bearing ring (4) and the inner surface (2a) of the inner mantle ring (2), said outer surface (4b) of the inner bearing ring (4) and inner surface (2a) of the inner mantle ring (2) being spherical, said eccentric inner ring (7) being slideable on the outer surface (4b) of the inner bearing ring (4) and on the inner surface (2a) of the inner mantle ring (2).
